(19) United States
(12) Patent Application Publication
(10) Pub. No.: US 2004/0146041 A1
(43) Pub. Date: Jul. 29, 2004

(54) Method of providing broadcast/multicast service

(76) Inventors: Young-Dae Lee, Gyeonggi-do (KR); Seung-June Yi, Seoul (KR); So-Young Lee, Gyeonggi-do (KR)

Correspondence Address: Song K. Jung, MCKENNA LONG & ALDRIDGE LLP, 1900 K Street, N.W., Washington, DC, 20006, US

(21) Appl. No.: 10/753,410

(22) Filed: Jan. 9, 2004

(30) Foreign Application Priority Data
Jan. 11, 2003 (KR) 10-2003-001864

(51) Int. Cl. H04J 3/24

(52) U.S. Cl. 370/349

(57) ABSTRACT

Methods and system for preventing waste of radio resources in a communication system capable of providing a multimedia broadcast/multicast service. The methods and systems involve generating and broadcasting radio access capability information associated with a specific service. This information is received by one or more terminals which then use the information to determine if they have the requisite capability to receive the service. Radio bearers are established for those terminals that have the capability to receive the service.

This application claims the benefit of Korean Application No. 2003-001864, filed on Jan. 11, 2003, which is hereby incorporated by reference.

### BACKGROUND OF THE INVENTION

1. Field of the Invention

The present invention relates to a communication system, and more particularly, to a method of providing a broadcast/multicast service that prevents the wasting of radio resources caused by the broadcasting of radio access capability information on downlink.

2. Discussion of the Related Art

The Universal Mobile Telecommunications System (UMTS) is a third generation mobile communication system that has evolved from the Global System for Mobile Communications (GSM) as a European standard. UMTS aims to provide improved mobile communication services based on a GSM core network and wideband code division multiple access.

To standardize UMTS, on December in 1998, ETSI (Europe), ARIB/TTC (Japan), T1 (U.S.A.), TTA (Korea), and the like, have launched the Third Generation Partnership Project (hereinafter “3GPP”). A detailed specification of UMTS is being composed.

For quick and efficient technological development of UMTS, 3GPP has divided the standardization work into five technical specification groups (hereinafter “TSGs”) to consider network elements and their operational independencies.

Each TSG takes charge of the development, approval, and management of a corresponding standard within a related area. A radio access network (hereinafter “RAN”) group of a TSG (TSG RAN) develops the functional, requirement, and interface specifications for a UMTS terrestrial radio access network (hereinafter “UTRAN”), a new radio access network supporting WCDMA access technology in UMTS.

FIG. 1 is a block diagram of a general network architecture for UMTS. As shown in FIG. 1, a UMTS system includes a terminal 100, a UTRAN 200 and a core network 300.

The UTRAN 200 includes one or more radio network subsystems 10a-10n. Each of the radio network subsystems 10a-10n includes a radio network controller (hereinafter “RNC”) 12 and 14, and one or more nodes B 11a-11b and 13a-13b. The nodes B 11a-11b and 13a-13b are managed by the corresponding RNC 12 and 14. The nodes B 11a-11b and 13a-13b receive uplink signals transmitted from the terminal 100 on a physical layer and transmit downlink signals to the terminal 100. Accordingly, the nodes B 11a-11b and 13a-13b perform the function of transmitting/receiving signals to/from the terminal 100, thereby serving as an access point to connect the terminal 100 to the UTRAN 200. The RNCs 12 and 14 take charge of resource allocation and management, in addition, they serve as the access point to connect the nodes B 11a-11b and 13a-13b to the core network 300.

The UTRAN 200 establishes a radio access bearer (hereinafter “RAB”) for communication between the terminal 100 and the core network 300. The UTRAN 200 also maintains and manages the RAB. The core network 300 applies end-to-end quality of service (hereinafter “QoS”) requirements to the RAB. As such, the RAB supports the QoS requirements set by the core network 300. Hence, the UTRAN 200 establishes, maintains, and manages the RAB, thereby helping to assure the end-to-end QoS requirements are met.

The RAB service involves an Iu bearer service and a radio bearer service. The Iu bearer service provides reliable transmission of user data between the UTRAN 200 and the core network 300. The radio bearer service provides reliable transmission of user data between the terminal 100 and the UTRAN 200.

FIG. 2 is a block diagram of a radio access interface protocol between a terminal 100 and a UTRAN 200 based on 3GPP radio access network specifications. Referring to FIG. 2, a radio access interface protocol vertically includes a physical layer PHY, a data link layer, and a network layer. The radio access interface protocol is horizontally divided into a user plane for transmission of user traffic or data information and a control plane for transmission of control signals (signaling). In the user plane, the transmission of user's traffic or data information involves the transmission of voice or Internet protocol (hereinafter “IP”) packets. In the control plane, the control signals are used for transmitting information relating to the maintenance, management, and the like, of the network interface and call/connection.

The protocol layers in FIG. 2 are divided into an L1 (first layer), an L2 (second layer), and an L3 (third layer) layer based on three lower layers of an open system interconnection (OSI) reference model, which is well known in the art.

The L1 layer provides the higher layers with an information transfer service through the use of various radio transmission techniques. The L1 layer is connected to a medium access control (hereinafter “MAC”) layer via transport channels. Likewise, data is transferred between the MAC layer and the physical layer via transport channels.

The MAC layer provides an allocation service for radio resource allocation/re-allocation. The MAC layer is connected to a radio link control (hereinafter “RLC”) layer via logical channels. There are various types of logical channels in accordance with the types of data and information transferred between the MAC and RLC layers. Generally, control type channels are used if the information being transferred relates to the control plane, while traffic type channels are used if the information being transferred relates to the user plane.

The RLC layer supports reliable data transmission and carries out segmentation and concatenation of RLC service data units (hereinafter “SDUs”), which are transferred from the higher layers. For instance, the size of an SDU transferred from the higher layer is adjusted in accordance with the handling capacity. Header information is then added thereto and the SDU is transferred to the MAC layer in the form of a protocol data unit (hereinafter “PDU”). The RLC layer includes an RLC buffer for storing RLC SDUs and RLC PDUs.

A broadcast/multicast control (hereinafter “BMC”) layer carries out scheduling for cell broadcast (hereinafter “CB”) messages transferred from the core network. CB messages are thus broadcasted to the corresponding UEs located in a specific cell(s) based on the scheduling.

A packet data convergence protocol (hereinafter “PDCP”) layer is above the RLC layer. It enables data transmitted in accordance with a network protocol, such as IPv4 or IPv6, to be effectively transmitted over a radio interface having relatively small bandwidth. For such a purpose, the PDCP layer reduces unnecessary control information that is otherwise used in wire networks. This function is called header compression. For header compression, the PDCP layer may use robust header compression (ROHC) such as RFC2507 or RFC3095, which are methods defined by the Internet Standardization Group called IETF (Internet Engineering Task Force).

A radio resource control (hereinafter “RRC”) layer located in the lowest part of the L3 layer is in the control plane only, as illustrated in FIG. 2. The RRC layer controls the transport and physical channels with respect to establishing, reconfiguring and releasing radio bearers (hereinafter “RBs”). In this case, RB refers to a service provided by the second layer for data transmission between the UE and UTRAN. The establishment of RB refers to procedures prescribing characteristics of protocol layers and channels required for providing a specific service and setting the respective specific parameters and operational methods.

A multimedia broadcast/multicast service (hereinafter abbreviated MBMS) is explained in detail as follows. MBMS is a downlink dedicated service that provides a plurality of terminals with a streaming or background service using common or dedicated downlink channels. The MBMS is divided into a broadcast mode and a multicast mode. The MBMS broadcast mode involves transmitting multimedia data to all terminals in a broadcast area. The broadcast area is an area in which a broadcast service is available. On the other hand, the MBMS multicast mode involves transmitting multimedia data to a specific group of terminals in a multicast area. The multicast area is an area in which a multicast service is available.

Each terminal requesting to receive MBMS should receive a service announcement message from the network. The service announcement message provides each terminal with list of MBMS services provided.

Terminals requesting MBMS multicast mode should join a multicast group to receive a specific multicast service. Thus, a multicast group is a group of terminals receiving a specific multicast service. Joining a multicast group is called MBMS multicast activation. Once activated, a user receives specific multicast data from the service.

As state, each terminal requesting the MBMS service should receive a notification message from the network. The notification message provides the terminal with information about incoming MBMS data, such as radio bearer establishment information for the MBMS service.

Notification messages are also sent for the purpose of counting the number of the terminals requesting the MBMS service in a cell. If a terminal requesting the MBMS service receives a notification message, it responds to the notification message. The communication system then counts the number of responses. A terminal may respond by sending an RRC connection request message.

There are two RB types associated with MBMS: point-to-point and point-to-multipoint. The communication system determines the RB type after counting the number of the terminals. If there are but a few terminals in a cell, the communication system will employ a point-to-point radio bearer. Otherwise, the communication system will employ a point-to-multipoint radio bearer.

When the communication system provides corresponding terminals with the MBMS service, the following problems may occur.

First, when a specific terminal is provided with the MBMS service, the terminal should have the capabilities required to support the corresponding MBMS service. However, it is nearly impossible for all the terminals to have the capabilities required for the MBMS service. It is therefore better if the communication system considers the capabilities of as many terminals as possible when configuring the RB for the MBMS service. However, in this case, the communication system has difficulty acquiring the capabilities of a plurality of terminals before configuring the RB, especially if the number of terminals is large. Also, if the terminals are required to inform the communication system of their capabilities, this will increase the level of interference and load for the uplink.

Second, when the communication system determines the number of terminals requesting the MBMS service, that number may not be overly useful because it may include terminals which do not have the required capabilities. For this reason, the communication system could incorrectly establish the radio bearer and, as a result, waste system resources.

Finally, a terminal that does not have the capabilities required by the MBMS service will perform unnecessary operations if it is provided with the MBMS broadcast mode service or if it is provided with MBMS service in idle mode. That is because the terminal is unable to recognize whether it has the required capabilities before trying to configure a radio bearer of the MBMS service. Hence, the above-mentioned problem can increase the level of interference and load on the uplink, increase errors and result in the waste of the communication resources.

### SUMMARY OF THE INVENTION

The present invention is directed to a method of providing a broadcast/multicast service and a system thereof that substantially obviates one or more problems due to the aforementioned limitations and disadvantages of the related art.

Accordingly, an object of the present invention is to provide a method and a system for a broadcast/multicast service that minimize interference and load on the uplink.

Another object of the present invention is to provide a method and a system for a broadcast/multicast service that establishes an appropriate radio bearer.

Another object of the present invention is to provide a method and a system for a broadcast/multicast service that prevents the waste of communication resources.

A further object of the present invention is to provide a method and a system for a broadcast/multicast service suitable for providing a broadcast mode.

Another further object of the present invention is to provide a method and a system for a broadcast/multicast service suitable for providing idle mode.

Additional advantages, objects, and features of the invention will be set forth in the description which follows and become apparent to those having ordinary skill in the art. The objectives and other advantages of the invention may be realized and attained by the structure particularly pointed out in the written description and claims hereof as well as the appended drawings.

To achieve these objects and other advantages and in accordance with the purpose of the invention, as embodied and described herein, a method of providing a broadcast/multicast service in a communication system according to the present invention includes the steps of generating capability information required for receiving a specific service, transmitting the generated capability information to a plurality of terminals requesting to receive the service, and having each of the terminals requesting to receive the service determine whether the service reception is available or not, wherein each of the terminals requesting the service has received the capability information.

It is to be understood that both the foregoing description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this description.

FIG. 1 is a block diagram of a general network architecture of UMTS;

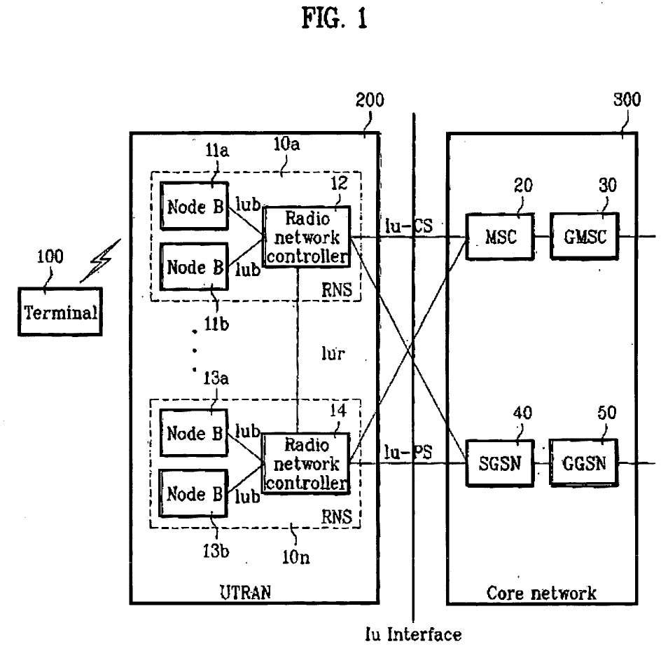

FIG. 2 is a diagram of a structure for a radio access interface protocol between a terminal and a UTRAN based on 3GPP radio access network specifications;

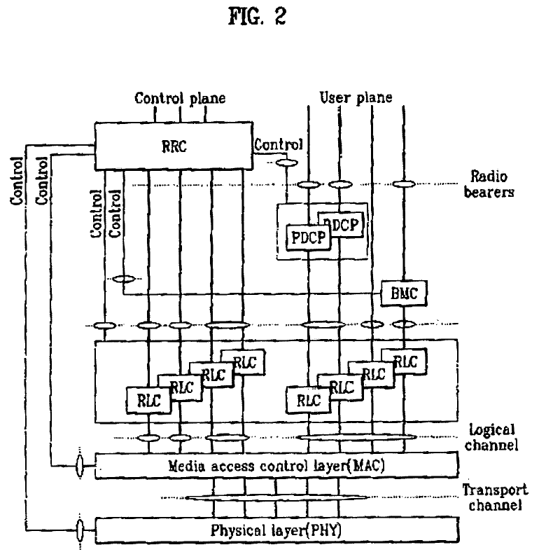

FIG. 3 is a flowchart of a radio access capability information transmission/reception procedure according to one embodiment of the present invention; and

FIG. 4 is a flowchart of a radio access capability information transmission/reception procedure according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In a system that provides a plurality of terminals with specific services, the present invention is directed to communication systems and methods characterized in that radio access capability information is transmitted to a plurality of the terminals. That information sets forth the radio access capability required in order for a terminal to receive a specific, corresponding service.

More specifically, in a communication system providing a plurality of terminals with a broadcast or/and multicast service through a downlink channel, the present invention proposes a communication system characterized in that radio access capability information required for accessing the broadcast/multicast services is transmitted to a plurality of the terminals. Hence, the communication system prevents terminals, which do not have the capabilities required to receive the broadcast and/or multicast service, from accessing the communication system unnecessarily. Specifically, when the communication system checks the number of the terminals requesting the broadcast and/or multicast service to establish a MBMS radio bearer, the present invention prevents terminals that do not have the capabilities required to receive the broadcast and/or multicast service from accessing the communication system, thereby preventing radio communication resources from being wasted.

Moreover, the present invention provides terminal communication systems and methods characterized in that a plurality of terminals, requesting a broadcast and/or multicast service, receive radio access capability information required for a corresponding service from the communication system.

Specifically, the present invention provides terminal communication systems and methods characterized in that a plurality of terminals, receiving a broadcast and/or multicast service from a fixed station through a downlink channel, receive radio access capability information required for a corresponding service from the communication system. Each of the terminals compares the received radio access capability requirements to its radio access capability, and determines whether it has the required capabilities. If the terminal has the required capabilities, the terminal receives the broadcast and/or multicast service. If the terminal does not have the required capabilities, the terminal aborts the process and access to the broadcast and/or multicast service is precluded.

In another embodiment, if a terminal has the required radio access capability, the terminal will transmit a response signal to the communication system. However, if the terminal does not possess the capability, the terminal will not transmit a response signal to the communication system. Where the terminal has the required capabilities, it means that the terminal is capable of supporting all of the functions and operations associated with the broadcast and/or multicast service and, therefore, capable of receiving the service without malfunction. Where the terminal does not have the required capabilities, it means that the terminal cannot support at least a certain part of the functions or operations associated with the broadcast and/or multicast service and, therefore, incapable of receiving the service without malfunction.

The radio access capability information that is transmitted to the terminals includes functional parameters and/or operational parameters corresponding to the broadcast and/or multicast service. Preferably, the radio access capability information also includes radio protocol configuration information, i.e., information relating to the function and/or operation of the PDCP, RLC, MAC and physical layers, as well as various parameter information relating to radio bearer establishment. With specific regard to the PDCP layer, the radio access capability information may include information that instructs the terminals that they must be capable of supporting a specific header compression algorithm. With specific regard to the physical layers, the radio access capability information may include information needed for simultaneous reception over a SCCPCH and a DPCH, information that the number of SCCPCHs needed for simultaneous reception is at least three, information that the PDSCH (physical downlink shared channel) should be used for reception, and other the like information that the terminals need in order to determine whether they can receive the specific service given their radio access capabilities. Generally speaking, it is the UTRAN that sets the parameters associated with the radio bearer and the transport and/or physical channels, given the specific service, and includes them in the radio access capability information transmitted to the terminals.

As stated, some terminals may not possess the radio access capabilities required for a corresponding broadcast and/or multicast service. These terminals, therefore, cannot receive the corresponding service. However, other terminals will possess the radio access capabilities required for the corresponding broadcast and/or multicast service. Here, the terminals will receive the corresponding service. For instance, if a particular header compression function, associated with the PDCP, is included in the radio access capability information, any terminal failing to support this header compression function is deemed unable to support the radio access capability, whereas any terminal that does support the header compression function may possess the requisite radio access capability. In another instance, if information requiring simultaneous reception of three common physical channels in the physical layer is included in the radio access capability information, a terminal unable to simultaneously receive three common physical channels does not possess the requisite radio access capability, where a terminal that is able to receive three common physical channels may possess the requisite radio access capability.

The radio access capability information transmitted to the terminals may include all of the radio access capability information (i.e., comprehensive information), a portion of the overall information, or a class indicator. More specifically, the UTRAN may transmit all of the radio access capability information associated with the specific broadcast and/or multicast service to all of the terminals, or the UTRAN may transmit a portion of the radio access capability information to the terminals. When only a portion of the radio access capability information is transmitted, the information includes at least the essential requirements. In accordance with another method, the UTRAN classifies radio access capability information into several different classes, where each is identifiable by a unique class indicator, so that a class indicator may be transmitted to the terminals instead a comprehensive set of information or a portion of the comprehensive set of information. In order to support this latter method, the UTRAN and the terminal store the radio access capability information for each of the different classes, where the stored radio access capability information for each class includes a set of radio access capability information required for supporting a prescribed MBMS service. Accordingly, the terminal is able to determine which set of stored radio access capability information is applicable when it receives the class indicator.

The UTRAN periodically transmits the radio access capability information to the terminals. The UTRAN also transmits the radio access capability information more than one time (i.e., repeatedly), where the number of repetitions may be specified. In this case, the radio access capability information can be included in a paging message or in a notification message transmitted to the terminals.

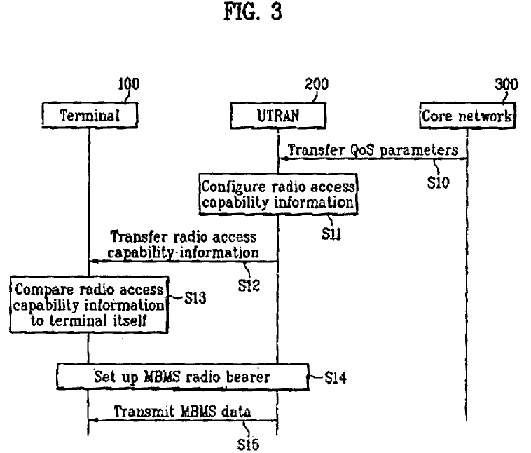

FIG. 3 is a flowchart depicting a procedure for transmitting/receiving radio access capability information according to one embodiment of the present invention. This procedure may be used where it is unnecessary to count the number of terminals requesting the specific MBMS service in a specific cell. For instance, the procedure can be used if the cell does not count the number of the terminals requesting the MBMS service, if the terminals having no RRC connection in idle mode are provided with the MBMS service, or if the corresponding MBMS service in broadcast mode is provided.

Further in accordance with the procedure illustrated in FIG. 3, a core network 300 transfers quality of service (QoS) parameter information (S10) required for the MBMS service to a RNC 12, 14 in UTRAN 200. The RNC 12, 14 in UTRAN 200 uses the received QoS information to configure the radio access capability information (S11). The RNC 12, 14 singly configures the radio access capability information for a specific broadcast or multicast service. RRC of the UTRAN 200 then broadcasts the configured radio access capability information to the RRC of each terminal (S12).

The RRC of each terminal receives the radio access capability information, compares the received radio access capability to its own capability, and then determines whether it possesses the required capabilities (S13). As a result of the comparison, each terminal possessing the requisite capabilities establishes a radio bearer for the specific broadcast and/or multicast service in the UTRAN in order to receive the specific broadcast and/or multicast service (S14). Also, as a result of the comparison, those terminals that do not possess the requisite capabilities do not establish a radio bearer for the specific broadcast and/or multicast service.

The data associated with the MBMS service is then transmitted to a corresponding terminal, from the RNC 12, 14 through a node B11, 13 using a service of the user plane in a UTRAN protocol. A MBMS radio bearer transfers the MBMS data on the downlink. The established MBMS radio bearer carries out the function of transmitting the data for a single, specific MBMS service, which has been transferred to the UTRAN 200 from the core network 300, to a specific group of terminals.

Terminals that have established an MBMS radio bearer receive the MBMS data; terminals failing to establish an MBMS radio bearer do not receive the data.

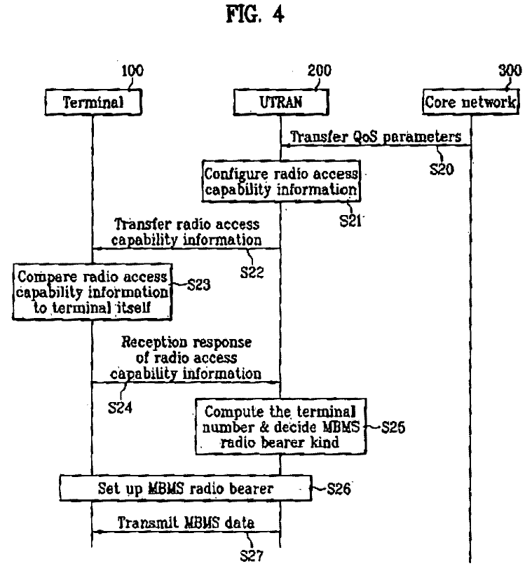

FIG. 4 is a flowchart of a procedure for transmitting/receiving radio access capability information according to another embodiment of the present invention. In this procedure, the UTRAN 200 decides the type of MBMS radio bearer by counting the number of terminals requesting the MBMS service in a specific cell. As shown, a core network 300 transfers QoS parameter information (S20), required for the specific MBMS service, to a RNC 12, 14 in the UTRAN 200. The RNC 12, 14 in the UTRAN 200 then configures the radio access capability information (S21) using the received QoS information. The RNC 12, 14 in the UTRAN 200 singly configures the radio access capability information for each specific broadcast and/or multicast service. In order to count the number of terminals requesting the specific MBMS service in the specific cell, the RRC in the UTRAN 200 broadcasts a counting message that includes the configured radio access capability information to the RRCs in the terminals (S22).

The RRC in each terminal acquires the radio access capability information from the counting message, compares the acquired radio access capability to its capability, and, based thereon, then determines whether it possesses the required capability (S23). As a result, each terminal that possesses the requisite capability transmits a response signal to the UTRAN 200 in response to the counting message. If, however, a terminal does not possess the requisite capability, the terminal does not transmit a signal in response to the counting message. The UTRAN 200 receives the response signals (S24) and there from computes the number of the terminals that transmitted a response (S25). If the number of terminals transmitting a response is equal to or greater than a prescribed threshold value, the UTRAN 200 sets up a point-to-multipoint MBMS radio bearer (S26). The point-to-multipoint MBMS radio bearer is set up through a common channel between a communication system providing the MBMS service and a plurality of corresponding terminals. On the other hand, if the number of terminals that transmitted a response is smaller than the prescribed threshold value, the UTRAN 200 sets up a point-to-point MBMS radio bearer (S26). The point-to-point MBMS radio bearer is set up between the communication system providing the MBMS service and each of the corresponding terminals. More particularly, the RRC of the UTRAN 200 sets up the MBMS radio bearer of according to the determination based on the signals received from the terminals in response to the counting message. Thus, the terminals that do not possess the requisite radio access capability, do not establish a radio bearer for the specific MBMS service. Finally, the UTRAN 200 transmits MBMS data to those terminals capable of supporting the service over the MBMS radio bearer set up for that MBMS service (S27).

Accordingly, the present invention has the following effects or advantages. First, the present invention prevents terminals that lack the requisite access capability from accessing the system unnecessarily and, in doing so, it conserves resources. Secondly, the present invention determines the number of terminals having the requisite capabilities, and then using that number to establish the appropriate MBMS radio bearer, thereby providing a more effective system.

Thirdly, the present invention minimizes interference and load on uplink.

Finally, the present invention provides terminals in idle mode with the broadcast and/or multicast service.

It will be apparent to those skilled in the art that various modifications and variations can be made in the present invention. Thus, it is intended that the present invention covers various modifications and variations provided they come within the scope of the appended claims and their equivalents.

What is claimed is:

1. A method of providing a service in a mobile communication system having a plurality of terminals, a fixed station and a protocol that includes a physical layer and a plurality of upper layers, said method comprising the steps of:
broadcasting access capability information associated with the service;
receiving the access capability information at one of the plurality of terminals;
comparing the access capability information to access capability associated with the terminal; and
establishing the service for the terminal based on the result of the comparison.

2. The method of claim 1, wherein the service is a multimedia broadcast/multicast service.

3. The method of claim 2, wherein said step of establishing the multimedia broadcast/multicast service comprises the step of:
establishing a multimedia broadcast/multicast service radio bearer.

4. The method of claim 1, wherein said step of broadcasting access capability information comprises the step of:
broadcasting functional and operational parameters associated with the service.

5. The method of claim 1, wherein said step of broadcasting access capability information comprises the step of:
broadcasting header compression information.

6. The method of claim 1, wherein said step of broadcasting access capability information comprises the step of:
broadcasting a class indicator, wherein the class indicator represents access capability information.

7. A method of providing a service in a mobile communication system having a plurality of terminals and a fixed station, said method comprising the steps of:
broadcasting access capability information for a specific service;
at one of the plurality of terminals, receiving the access capability information;
comparing the access capability information to access capability information associated with the terminal;
transmitting a response signal from the terminal to the fixed station based on the result of the comparison; and
establishing the service for the terminal.

8. The method of claim 7, wherein the service is a multimedia broadcast/multicast service.

9. The method of claim 8 further comprising the steps of:
transferring Quality of Service (QoS) information from a core network to a Radio Network Controller within the fixed station;
configuring the access capability information based on the Quality of Service information.

10. The method of claim 18, wherein said step of establishing the service comprises the steps of:
determining a number of terminals that transmitted a signal to the fixed station in response to receiving the access capability information;
establishing a point-to-multipoint MBMS radio bearer if the number of terminals that transmitted a signal to the fixed station in response to receiving the access capability information is above a predefined threshold; and
transmitting MBMS data over the point-to-multipoint MBMS radio bearer.

11. The method of claim 18, wherein said step of establishing the service comprises the steps of:
determining a number of terminals that transmitted a signal to the fixed station in response to receiving the access capability information;
establishing a point-to-point MBMS radio bearer if the number of terminals that transmitted a signal to the fixed station in response to receiving the access capability information is below a predefined threshold; and
transmitting MBMS data over the point-to-point MBMS radio bearer.

12. A method of establishing a multimedia broadcast/multicast service in a mobile communication system having a plurality of terminals and a fixed station, said method comprising the steps of:
at one of the plurality of terminals, receiving radio access capability information associated with the multimedia broadcast/multicast service;
comparing the received radio access capability information to radio access capability information associated with the terminal; and
establishing a multimedia broadcast/multicast service radio bearer, based on the result of the comparison.

13. The method of claim 12, wherein said step of receiving radio access capability information comprises the step of:
receiving a class indicator that represents a predefined access capability.

14. The method of claim 13, wherein said step of comparing the received radio access capability to the radio access capability associated with the terminal comprises the step of:
comparing the received class indicator to a class indicator associated with the terminal.

15. The method of claim 12, wherein the received radio access capability information represents a portion of the radio access capability information associated with the multimedia broadcast/multicast service.

16. A method of establishing a multimedia broadcast/multicast service in a mobile communication system having a plurality of terminals and a fixed station, said method comprising the steps of:
at one of the plurality of terminals, receiving radio access capability information associated with the multimedia broadcast/multicast service;
comparing the received radio access capability information to radio access capability that is associated with the terminal;
transmitting from the terminal to the fixed station a request to receive the multimedia broadcast/multicast service based on the result of the comparison; and
establishing a multimedia broadcast/multicast service radio bearer.

17. The method of claim 16, wherein said step of receiving radio access capability information comprises the step of:
receiving a class indicator that represents a predefined access capability.

18. The method of claim 17, wherein said step of comparing the received radio access capability to the radio access capability associated with the terminal comprises the step of:
comparing the received class indicator to a class indicator associated with the terminal.

19. The method of claim 16, wherein the received radio access capability information represents a portion of the radio access capability information associated with the multimedia broadcast/multicast service.

20. The method of claim 16, where said step of establishing the multimedia broadcast/multicast service radio bearer comprises the steps of:
determining a number of terminals that transmitted a request to receive the multimedia broadcast/multicast service;
establishing a point-to-multipoint MBMS radio bearer if the number of terminals that transmitted a request is above a predefined threshold; and
transmitting MBMS data over the point-to-multipoint MBMS radio bearer.

21. The method of claim 16, where said step of establishing the multimedia broadcast/multicast service radio bearer comprises the steps of:
determining a number of terminals that transmitted a request to receive the multimedia broadcast/multicast service;
establishing a point-to-point MBMS radio bearer if the number of terminals that transmitted a request is below a predefined threshold; and
transmitting MBMS data over the point-to-point MBMS radio bearer.

22. A radio communication system capable of providing a multimedia broadcast/multicast service, said radio communication system comprising:
a fixed station including means for broadcasting radio access capability information; and
a mobile terminal including means for receiving the radio access capability information and means for comparing the received radio access capability information to radio access capability information associated with the mobile terminal, wherein the fixed station and the mobile terminal each comprise a radio resource controller including means for establishing a multimedia broadcast/multicast radio bearer based on the result of the comparison between the received radio access capability information and the radio access capability information associated with the mobile terminal

23. The system of claim 22, wherein said fixed station further comprises:
means for utilizing the multimedia broadcast/multicast service radio bearer to transmit multimedia broadcast/multicast service data to said mobile terminal on a downlink.

24. The system of claim 22, wherein said mobile terminal further comprises:
means for determining whether it has the radio access capability required to receive the multimedia broadcast/multicast service; and
means for transmitting a response signal to said fixed station if it has been determined that mobile terminal has the required radio access capability.

25. The system of claim 24, wherein said fixed station further comprises:
means for receiving the response signal from said mobile terminal and from a plurality of additional mobile terminals associated with the system.

26. The system of claim 25, wherein the multimedia broadcast/multicast service radio bearer is a point-to-point radio bearer if the number of mobile terminals transmitting a response signal to the fixed station is less than a predefined threshold value.

27. The system of claim 25, wherein the multimedia broadcast/multicast service radio bearer is a point-to-multipoint radio bearer if the number of mobile terminals transmitting a response signal to the fixed station is greater than a predefined threshold value.

28. A mobile terminal operating in a radio communication system capable of providing a multimedia broadcast/multicast service, said mobile terminal comprising:
means for receiving radio access capability information from a fixed station associated with the radio communication system; and
means for comparing the received radio access capability information to stored radio access capability information associated with the mobile terminal, means for receiving multimedia broadcast/multicast service data over a radio bearer based on the result of the comparison between the received radio access capability information and the stored radio access capability information associated with the mobile terminal.

29. The mobile terminal of claim 28 further comprising:
means for determining whether it has the radio access capability required to receive the multimedia broadcast/multicast service based on the result of the comparison between the received radio access capabality information and the stored radio access capability information; and
means for transmitting a response signal to the fixed station if it has been determined that mobile terminal has the required radio access capability.
